(19) United States
(12) Patent Application Publication
(10) Pub. No.: US 2002/0177449 A1
(43) Pub. Date: Nov. 28, 2002

(54) Location-based data access control

(76) Inventors: James Thomas Edward McDonnell, Vicarage (GB); Andrew Thomas, Atherton, CA (US); John Deryk Waters, Bath (GB); Simon Edwin Crouch, Bristol (GB); Paul Vickers, West Clevedon (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/032,000

(22) PCT Filed: May 23, 2001
(86) PCT No.: PCT/GB01/02291

(30) Foreign Application Priority Data
May 24, 2000 (GB) 0012445.3

(51) Int. Cl. H04M 1/66; H04M 1/68; H04M 3/16; H04Q 7/20

(52) U.S. Cl. 455/456; 455/411

(57) ABSTRACT

In order to restrict access to content data held on a removable data carrier (83) or included in an electronic file, equipment (70) for accessing this content is arranged only to be enabled upon a location condition being satisfied. This condition is tested for by obtaining current-location data (67) representing the current location of the equipment, and comparing the current-location data with authorized-location data representing a predetermined authorized location or locality for operation of the equipment. The authorized location data may be stored in the equipment itself, in a remote system (42), or in the removable data media or received data file.

### FIELD OF THE INVENTION

The present invention relates to location-based control of the access to data stored on a removable data carrier or contained in a received data file.

### BACKGROUND OF THE INVENTION

Communication infrastructures suitable for mobile users (in particular, though not exclusively, cellular radio infrastructures) have now become widely adopted. Whilst the primary driver has been mobile telephony, the desire to implement mobile data-based services over these infrastructures, has led to the rapid development of data-capable bearer services across such infrastructures. This has opened up the possibility of many Internet-based services being available to mobile users.

By way of example, FIG. 1 shows one form of known communication infrastructure for mobile users providing both telephony and data-bearer services. In this example, a mobile entity 20, provided with a radio subsystem 22 and a phone subsystem 23, communicates with the fixed infrastructure of GSM PLMN (Public Land Mobile Network) 10 to provide basic voice telephony services. In addition, the mobile entity 20 includes a data-handling subsystem 25 interworking, via data interface 24, with the radio subsystem 22 for the transmission and reception of data over a data-capable bearer service provided by the PLMN; the data-capable bearer service enables the mobile entity 20 to communicate with a service system 40 connected to the public Internet 39. The data handling subsystem 25 supports an operating environment 26 in which applications run, the operating environment including an appropriate communications stack.

More particularly, the fixed infrastructure 10 of the GSM PLMN comprises one or more Base Station Subsystems (BSS) 11 and a Network and Switching Subsystem NSS 12. Each BSS 11 comprises a Base Station Controller (BSC) 14 controlling multiple Base Transceiver Stations (BTS) 13 each associated with a respective “cell” of the radio network. When active, the radio subsystem 22 of the mobile entity 20 communicates via a radio link with the BTS 13 of the cell in which the mobile entity is currently located. As regards the NSS 12, this comprises one or more Mobile Switching Centers (MSC) 15 together with other elements such as Visitor Location Registers 32 and Home Location Register 32.

When the mobile entity 20 is used to make a normal telephone call, a traffic circuit for carrying digitised voice is set up through the relevant BSS 11 to the NSS 12 which is then responsible for routing the call to the target phone (whether in the same PLMN or in another network).

With respect to data transmission to/from the mobile entity 20, in the present example three different data-capable bearer services are depicted though other possibilities exist. A first data-capable bearer service is available in the form of a Circuit Switched Data (CSD) service; in this case a full traffic circuit is used for carrying data and the MSC 32 routes the circuit to an Inter Working Function IWF 34 the precise nature of which depends on what is connected to the other side of the IWF. Thus, IWF could be configured to provide direct access to the public Internet 39 (that is, provide functionality similar to an IAP—Internet Access Provider IAP). Alternatively, the IWF could simply be a modem connecting to a PSTN; in this case, Internet access can be achieved by connection across the PSTN to a standard IAP.

A second, low bandwidth, data-capable bearer service is available through use of the Short Message Service that passes data carried in signalling channel slots to an SMS unit which can be arranged to provide connectivity to the public Internet 39.

A third data-capable bearer service is provided in the form of GPRS (General Packet Radio Service which enables IP (or X.25) packet data to be passed from the data handling system of the mobile entity 20, via the data interface 24, radio subsystem 21 and relevant BSS 11, to a GPRS network 17 of the PLMN 10 (and vice versa). The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the mobile entity 20 can exchange packet data via the BSS 11 and GPRS network 17 with entities connected to the public Internet 39.

The data connection between the PLMN 10 and the Internet 39 will generally be through a firewall 35 with proxy and/or gateway functionality.

Different data-capable bearer services to those described above may be provided, the described services being simply examples of what is possible.

In FIG. 1, a service system 40 is shown connected to the Internet 40, this service system being accessible to the OS/application 26 running in the mobile entity by use of any of the data-capable bearer services described above. The data-capable bearer services could equally provide access to a service system that is within the domain of the PLMN operator or is connected to another public or private data network.

With regard to the OS/application software 26 running in the data handling subsystem 25 of the mobile entity 20, this could, for example, be a WAP application running on top of a WAP stack where “WAP” is the Wireless Application Protocol standard. Details of WAP can be found, for example, in the book “Official Wireless Application Protocol” Wireless Application Protocol Forum, Ltd published 1999 Wiley Computer Publishing. Where the OS/application software is WAP compliant, the firewall will generally also serve as a WAP proxy and gateway. Of course, OS/application 26 can comprise other functionality (for example, an e-mail client) instead of, or additional to, the WAP functionality.

The mobile entity 20 may take many different forms. For example, it could be two separate units such as a mobile phone (providing elements 22-24) and a mobile PC (data-handling system 25) coupled by an appropriate link (wireline, infrared or even short range radio system such as Bluetooth). Alternatively, mobile entity 20 could be a single unit such as a mobile phone with WAP functionality. Of course, if only data transmission/reception is required (and not voice), the phone functionality 24 can be omitted; an example of this is a PDA with built-in GSM data-capable functionality whilst another example is a digital camera (the data-handling subsystem) also with built-in GSM data-capable functionality enabling the upload of digital images from the camera to a storage server.

Whilst the above description has been given with reference to a PLMN based on GSM technology, it will be appreciated that many other cellular radio technologies exist and can typically provide the same type of functionality as described for the GSM PLMN 10.

Recently, much interest has been shown in “location-based”, “location-dependent”, or “location-aware” services for mobile users, these being services that take account of the current location of the user (or other mobile party). The most basic form of this service is the emergency location service whereby a user in trouble can press a panic button on their mobile phone to send an emergency request-for-assistance message with their location data appended. Another well known location-based service is the provision of traffic and route-guiding information to vehicle drivers based on their current position. A further known service is a “yellow pages” service where a user can find out about amenities (shops, restaurants, theatres, etc.) local to their current location. The term “location-aware services” will be used herein to refer generically to these and similar services where a location dependency exists.

Location-aware services all require user location as an input parameter. A number of methods already exist for determining the location of a mobile user as represented by an associated mobile equipment. Example location-determining methods will now be described with reference to FIGS. 2 to 5. As will be seen, some of these methods result in the user knowing their location thereby enabling them to transmit it to a location-aware service they are interested in receiving, whilst other of the methods result in the user's location becoming known to a network entity from where it can be supplied directly to a location-aware service (generally only with the consent of the user concerned). It is to be understood that additional methods to those illustrated in FIGS. 2 to 5 exist.

As well as location determination, FIGS. 2 to 5 also illustrate how the mobile entity requests a location-aware service provided by service system 40. In the present examples, the request is depicted as being passed over a cellular mobile network (PLMN 10) to the service system 40. The PLMN is, for example, similar to that depicted in FIG. 1 with the service request being made using a data-capable bearer service of the PLMN. The service system 40 may be part of the PLMN itself or connected to it through a data network such as the public Internet. It should, however, be understood that infrastructure other than a cellular network may alternatively be used for malting the service request

The location-determining method illustrated in FIG. 2 uses an inertial positioning system 50 provided in the mobile entity 20A, this system 50 determining the displacement of the mobile entity from an initial reference position. When the mobile entity 20A wishes to invoke a location-aware service, it passes its current position to the corresponding service system 40 along with the service request 51. This approach avoids the need for an infrastructure to provide an external frame of reference; however, cost, size and long-term accuracy concerns currently make such systems unattractive for incorporation into mass-market handheld devices.

FIG. 3 shows two different location-determining methods both involving the use of local, fixed-position, beacons here shown as infra-red beacons IRD though other technologies, such as short-range radio systems (in particular, “Bluetooth” systems) may equally be used. The right hand half of FIG. 3 show a number of independent beacons 55 that continually transmit their individual locations. Mobile entity 20B is arranged to pick up the transmissions from a beacon when sufficiently close, thereby establishing its position to the accuracy of its range of reception. This location data can then be appended to a request 59 made by the mobile entity 20B to a location-aware service available from service system 40. A variation on this arrangement is for the beacons 55 to transmit information which whilst not directly location data, can be used to look up such data (for example, the data may be the Internet home page URL of a store housing the beacon 55 concerned, this home page giving the store location—or at least identity, thereby enabling look-up of location in a directory service).

In the left-hand half of FIG. 3, the IRB beacons 54 are all connected to a network that connects to a location server 57. The beacons 54 transmit a presence signal and when mobile entity 20C is sufficiently close to a beacon to pick up the presence signal, it responds by sending its identity to the beacon. (Thus, in this embodiment, both the beacons 54 and mobile entity 20C can both receive and transmit IR signals whereas beacons 55 only transmit, and mobile entity 20B only receives, IR signals). Upon a beacon 54 receiving a mobile entity's identity, it sends out a message over network 56 to location server 57, this message linking the identity of the mobile entity 20C to the location of the relevant beacon 54. Now when the mobile entity wishes to invoke a location-aware service provided by the service system 40, since it does not know its location it must include it's identity in the service request 58 and rely on the service system 40 to look up the current location of the mobile entity in the location server 57. Because location data is personal and potentially very sensitive, the location server 57 will generally only supply location data to the service system 40 after the latter has produced an authorizing token supplied by the mobile entity 20B in request 58. It will be appreciated that whilst service system 40 is depicted as handling service requests form both types of mobile entity 20B and 20C, separate systems 40 maybe provided for each mobile type (this is likewise true in respect of the service systems depicted in FIGS. 4 and 5).

FIG. 4 depicts several forms of GPS location-determining system. On the left-hand side of FIG. 4, a mobile entity 20D is provided with a standard GPS module and is capable of determining the location of entity 20D by picking up signals from satellites 60. The entity 20D can then supply this location when requesting, in request 61, a location-aware service from service system 40.

The right-hand side of FIG. 4 depicts, in relation to mobile entity 20E, two ways in which assistance can be provided to the entity in deriving location from GPS satellites. Firstly, the PLMN 10 can be provided with fixed GPS receivers 62 that each continuously keep track of the satellites 60 visible from the receiver and pass information in messages 63 to local mobile entities 20E as to where to look for these satellites and estimated signal arrival times; this enables the mobile entities 20E to substantially reduce acquisition time for the satellites and increase accuracy of measurement (see “Geolocation Technology Pinpoints Wireless 911 calls within 15 Feet” Jul. 1, 1999 Lucent Technologies, Bell Labs). Secondly, as an alternative enhancement, the processing load on the mobile entity 20E can be reduced and encoded jitter removed using the services of network entity 64 (in or accessible through PLMN 10).

One the mobile unit 20E has determined its location, it can pass this information in request 65 when invoking a location-aware service provided by service system 40.

FIG. 5 depicts two general approaches to location determination from signals present in a cellular radio infrastructure. First, it can be noted that in general both the mobile entity and the network will know the identity of the cell in which the mobile entity currently resides, this information being provided as part of the normal operation of the system. (Although in a system such as GSM, the network may only store current location to a resolution of a collection of cells known as a “location area”, the actual current cell ID will generally be derivable from monitoring the signals exchanged between the BSC 14 and the mobile entity). Beyond current basic cell ID, it is possible to get a more accurate fix by measuring timing and/or directional parameters between the mobile entity and multiple BTSs 13, these measurement being done either in the network or the mobile entity (see, for example, International Application WO 99/04582 that describes various techniques for effecting location determination in the mobile and WO 99/55114 that describes location determination by the mobile network in response to requests made by location-aware applications to a mobile location center—server—of the mobile network).

The left-hand half of FIG. 5 depicts the case of location determination being done in the mobile entity 20F by, for example, making Observed Time Difference (OTD) measurements with respect to signals from BTSs 13 and calculating location using a knowledge of BTS locations. The location data is subsequently appended to a service request 66 sent to service system 40 in respect of a location-aware service. The calculation load on mobile entity 20F could be reduced and the need for the mobile to know BTS locations avoided, by having a network entity do some of the work. The right-hand half of FIG. 5 depicts the case of location determination being done in the network, for example, by making Timing Advance measurements for three BTSs 13 and using these measurements to derive location (this derivation typically being done in a unit associated with BSC 14). The resultant location data is passed to a location server 67 from where it can be made available to authorised services. As for the mobile entity 20C in FIG. 3, when the mobile entity 20G of FIG. 5 wishes to invoke a location-aware service available on service system 50, it sends a request 69 including an authorisation token and its ID (possible embedded in the token) to the service system 40; the service system then uses the authorisation token to obtain the current location of the mobile entity 20G from the location server 67.

In the above examples, where the mobile entity is responsible for determining location, this will generally be done only at the time the location-aware service is being requested. Where location determination is done by the infrastructure, it may be practical for systems covering only a limited number of users (such as the system illustrated in the left-hand half of FIG. 2 where a number of infrared beacons 54 will cover a generally fairly limited) for location-data collection to be done whenever a mobile entity is newly detected by an IRB, this data being passed to location server 57 where it is cached for use when needed. However, for systems covering large areas with potentially a large number of mobile entities, such as the FIG. 5 system, it is more efficient to effect location determination as and when there is a perceived need to do so; thus, location determination may be triggered by the location server 67 in response to the service request 68 from the mobile entity 20G or the mobile entity may, immediately prior to making request 68, directly trigger BSC 14 to effect a location determination and feed the result to location server 67.

Further with respect to the location servers 57, 67, whilst access authorisation by location-aware services has been described as being through authorisation tokens supplied by the mobile entities concerned, other authorisation techniques can be used. In particular, a location-aware service can be prior authorised with the location server in respect of particular mobile entities; in this case, each request from the service for location data needs only to establish that the request comes from a service authorised in respect of the mobile entity for which the location data is requested.

As already indicated, FIGS. 2 to 5 depict only some examples of how location determination can be achieved, there being many other possible combinations of technology used and where in the system the location-determining measurements are made and location is calculated, stored and used. Thus, the location-aware service may reside in the mobile entity whose location is of interest, in a network-connected service system 40 (as illustrated), or even in another mobile entity. Furthermore, whilst in the examples of FIGS. 2 to 5, invocation of the location-aware service has been by the mobile entity whose location is of interest, the nature of the location-aware service may be such that it is invoked by another party (including, potentially, the PLMN itself). In this case, unless the invoking party already knows the location of the mobile entity and can pass this information to the location-aware service (which may, for example, may be situation where the PLMN invokes the service), it is the location-aware service that is responsible for obtaining the required location data, either by sending a request to the mobile entity itself or by requesting the data from a location server. Unless the location server already has the needed information in cache, the server proceeds to obtain the data either by interrogating the mobile entity or by triggering infrastructure elements to locate the mobile. For example, where a location-aware service running on service system 40 in FIG. 5 needs to find the location of mobile 20G, it could be arranged to do so by requesting this information from location server 67 which in turn requests the location data from the relevant BSC, the latter then making the necessary determination using measurements from BTSs 13.

Although in the foregoing, the provision of location data through the mobile radio infrastructure to the mobile entity has been treated as a service effected over a data-capable bearer channel, it may be expected that as location data becomes considered a basic element of mobile radio infrastructure services, provision will be made in the relevant mobile radio standards for location data to be passed over a signalling channel to the mobile entity.

It is an object of the present invention to provide an improved way of restricting access to electronic content data by using location information.

### SUMMARY OF THE INVENTION

According to one aspect of the present invention, there is provided a control method for an item of equipment that is provided with particular functionality for using target data on a removable data carrier or in a received data file, the method involving enabling said particular functionality upon at least a first location condition being satisfied, this condition being tested for by:

(a) obtaining current-location data representing the current location of the equipment;

(b) comparing the current-location data with authorised-location data that is associated with the target data and represents a predetermined authorised location or locality for operation of said particular functionality of the equipment in relation to the associated target data; and

(c) generating a location-match signal upon the comparison step (b) indicating that the equipment is currently located in said authorised location or locality.

According to a second aspect of the present invention, there is provided equipment including particular functionality for using target data provided on a removable data carrier or in a received data file, the equipment further including a control sub-system for enabling said particular functionality upon at least a first location condition being satisfied, the control sub-system comprising, for testing this condition:

a location discovery arrangement for obtaining current-location data representing the current location of the equipment;

a read arrangement for reading from the removable data carrier or received data file authorized-location data representing a predetermined authorized location or locality for operation of said particular functionality of the equipment; and

a comparison arrangement for comparing the current-location data with the authorized-location data whereby to generate a location-match signal upon this comparison indicating that the equipment is currently located in said authorised location or locality.

According to a third aspect of the present invention, there is provided equipment including particular functionality for using target data provided on a removable data carrier or in a received data file, the equipment further including a control sub-system for enabling said particular functionality upon at least a first location condition being satisfied, the control sub-system comprising, for testing this condition:

a location discovery arrangement for obtaining current-location data representing the current location of the equipment;

a store for storing in association with identity data, authorized-location data representing a predetermined authorized location or locality for operation of said particular functionality of the equipment

a read arrangement for reading from the removable data carrier or received data file identity information relating to the target data;

a data retrieval arrangement for using the identity information to access the authorized-location data held in said store in respect of the identity data matching the identity information; and

a comparison arrangement for comparing the current-location data with the accessed authorized-location data whereby to generate a location-match signal upon this comparison indicating that the equipment is currently located in said authorised location or locality.

According to a fourth aspect of the present invention, there is provided a service system for determining when an item of equipment is located at a location where particular functionality of the equipment is authorised for use in accessing target data provided on a removable data carrier or in a received data file, the service system comprising:

a communications sub-system for communicating with said equipment both to receive therefrom identity information concerning said target data, and to return to the equipment enablement signals for enabling said particular functionality for accessing the target data;

a location discovery arrangement for obtaining current-location data representing the current location of the equipment;

a store for storing in association with identity data, authorized-location data representing a predetermined authorized location or locality for operation of said particular functionality of the equipment;

a data retrieval arrangement for using identity information received from the equipment via the communication sub-system to access the authorized-location data held in said store in respect of identity data matches the identity information; and

a comparison arrangement for comparing the current-location data with the accessed authorized-location data whereby to generate a location-match signal upon this comparison indicating that the equipment is currently located in said authorised location or locality.

According to a fifth aspect of the present invention, there is provided a removable data carrier on which is registered target content data and authorised-location data, the latter representing a predetermined authorized location or locality where access to the target data is permitted.

### BRIEF DESCRIPTION OF THE DRAWINGS

A method and service-system, both embodying the present invention, for location-based equipment control, will now be described, by way of non-limiting example, with reference to the accompanying diagrammatic drawings, in which:

FIG. 1 is a diagram of a known communications infrastructure usable for transferring voice and data to/from a mobile entity;

FIG. 2 is a diagram illustrating one known approach to determining the location of a mobile entity, this approach involving providing the entity with an inertial positioning system;

FIG. 3 is a diagram illustrating another known approach to determining the location of a mobile entity, this approach being based on proximity of the mobile entity to fixed-position local beacons;

FIG. 4 is a diagram illustrating a further known approach to determining the location of a mobile entity, this approach involving the use of GPS satellites;

FIG. 5 is a diagram illustrating a still further approach to determining the location of a mobile entity, this approach being based on the use of signals present in a cellular mobile radio communications system;

FIG. 6 is a diagram illustrating a first embodiment of the invention, this embodiment involving a removable data carrier; and

FIG. 7 is a diagram illustrating a second embodiment of the invention, this embodiment also involving a removable data carrier.

### BEST MODE OF CARRYING OUT THE INVENTION

In certain situations it can be desirable to be able to restrict access to certain information media and data files such that they could only be read at particular locations (inside a secure building, for example). As will be described below, embodiments of the present invention provide ways of achieving this objective by deriving the location of the equipment used to access the information media/data files concerned and comparing this location with predetermined authorized-locations data that specifies where the equipment, or where the media/file, are authorized for use. Where this comparison determines that the equipment (or at least one function of the equipment) can legitimately be used, appropriate enablement signals are generated to enable the corresponding equipment functions.

Current location data about the equipment may be derived by the equipment itself or by a communications infrastructure (e.g. cellular radio network) with which the equipment communicates. As regards the authorised-locations data, this can be:

held in the equipment (and potentially modifiable under password control);

embedded in “content” (removable information media, received data file) which the equipment is intended to process in some way at authorised locations;

held at a remote server to which the equipment must refer; in this case, a reference identifying what authorised-locations data is relevant must be passed to the server (this reference could identify the equipment, a particular user, or the “content” concerned). The identifying reference may be provided from the equipment itself or from the communications infrastructure if known to the latter (which may well be the case if the reference concerns the identity of the equipment or user).

The comparison of equipment current location and the authorized location data can be effected at the equipment itself or at a remote authorization server; in this latter case, the server returns an authorization code only when the equipment location corresponds to the authorized location data.

Conditions additional to location can also be set on equipment enablement.

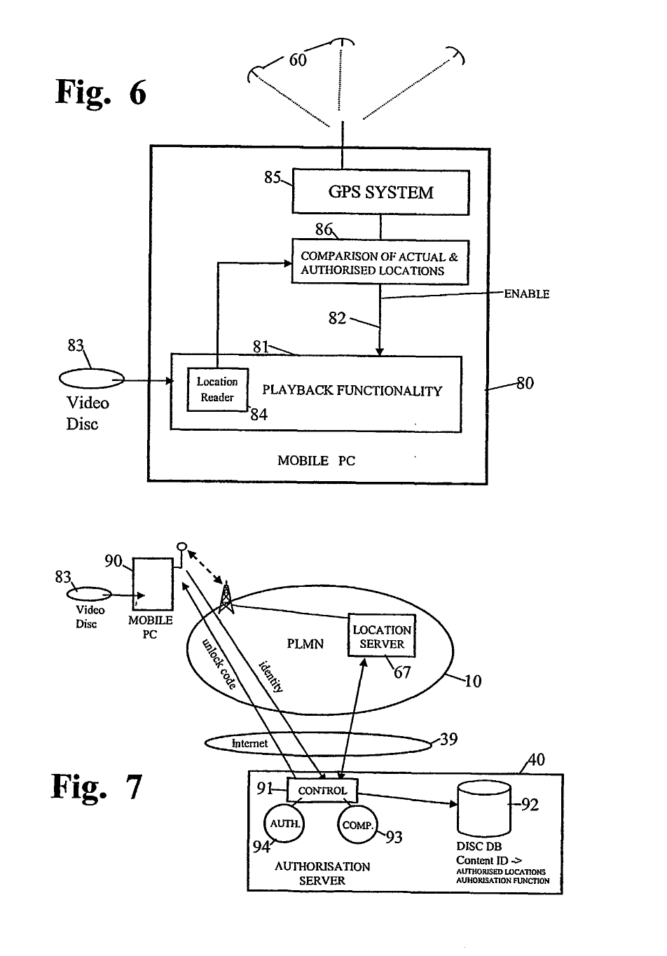

FIG. 6 illustrates a first embodiment of the invention in which a mobile device 80, such as a mobile PC, is only enabled to display a video disc 83 at an authorized location that is stored on the disc itself. The mobile device 80 includes playback functionality 81 that requires the presence of an enable signal on line 82 for it to display the contents of the disc. Playback functionality includes a location reader 84 operative (regardless of whether or not the enable signal is present) to read the authorized-location data off the disc 83 and pass it to a comparison unit 86 to which is also fed the current location of the device 20 as provided by a GPS system 85. Comparison unit 82 only generates the enable signal when the device current location corresponds to the authorized location data on the disc 83. Preferably, the video disc is encoded in a format that is only interpretable by devices having the location checking functionality built in. The relevant parts of device 80 are preferably of tamper-proof construction so as to prevent an end-user circumventing the location condition placed on access to the target information on the video disc.

FIG. 7 illustrates another embodiment where a mobile device 90, such as a mobile PC, is only enabled to decrypt and display a video disc 83 at a location specified in a database 92 associated with an authorisation server 40. The mobile device is equipped with cellular radio functionality enabling it to communicate with the server 40 using a data-capable bearer service of PLMN 10. The identity of the contents of the video disc 83 is read from the disc by the mobile device 90 and supplied to the authorisation server 40. Control process 91 obtains the current location of the mobile device from location server 67 of PLMN 10 and looks up the authorized location of playback of the contents of the video disc 83 by using the disc-contents identity to reference into database 92. Comparison process 93 compares the current device location with the authorized location. If the server finds that an authorized read location for the video-disc contents matches the current location of the mobile device, process 94 returns an enablement code (which may be a decryption key for the video disc contents, this key being held in database 92). Authorization may additionally be made dependent on the identity of the mobile PC or its user. For security reasons, the enablement code is preferably returned encrypted with a public key associated with the mobile device/user. During playing of the video disc, the content identity is arranged to be repeatedly read by device 90 so as to prevent the viewing of a different disc with different content under the authorisation granted for the original disc (this would only be possible if the discs were not encrypted or were encrypted with the same key).

Instead of a video disc 83, the embodiments of FIGS. 6 and 7 could equally be used in respect of other forms of removable data carriers or received data files (received, for example, via an internet or intranet connection to the equipment). Furthermore, the equipment used to access the information media/data file need not be portable equipment and could, for example, be normal desktop office or home equipment.

It will be appreciated that many different embodiments are possible in view of the variety of ways the location information and authorized-locations data can be derived. Furthermore, the desired level of security may determine the details of any particular implementation (in particular, various authentication techniques may need to be used to avoid location information being falsified).

It may be noted that it is possible to store the authorized-location data for the information media/data file in the equipment to be used for access the latter. This could be useful, for example, in restricting access to classified encrypted electronic documents of a company in dependence on the equipment location and classification level of a current document; to this end, the equipment is pre-programmed by the company with authorized location data (corresponding, for example, to company sites and locations within those sites) to be applied to particular document classification levels (the classification level of a document being stored with that document on the information media/file concerned and being read by the equipment). Thus, if the current location of the equipment is such that it is authorized to read documents of a classification level at least as high as that of a current document, then the equipment is enabled to use an appropriate decryption key (for example, stored in the equipment) for reading that electronic document. In this context, the classification level of the electronic document constitutes its identity.

Whilst in the described embodiments the location data has been expressed in terms of absolute location data, it would be possible also to use relative location data and also semantic location data (for example, the authorised locations could be specified as all premises of a particular company, in which case there would need to be a translation of this semantic location data to real world locations through, for example, a database that specifies the absolute locations of the company's current premises).

In the FIG. 7 embodiment, communication with the authorisation server 40 is described as being via a cellular radio connection. It would, of course, also be possible to used a wired connection (such as a LAN connecting to the Internet) with the current location of the device concerned being obtained by any appropriate manner.

Where a piece of equipment has multiple functional units, different functions of the equipment can be locationally limited to differing extents.

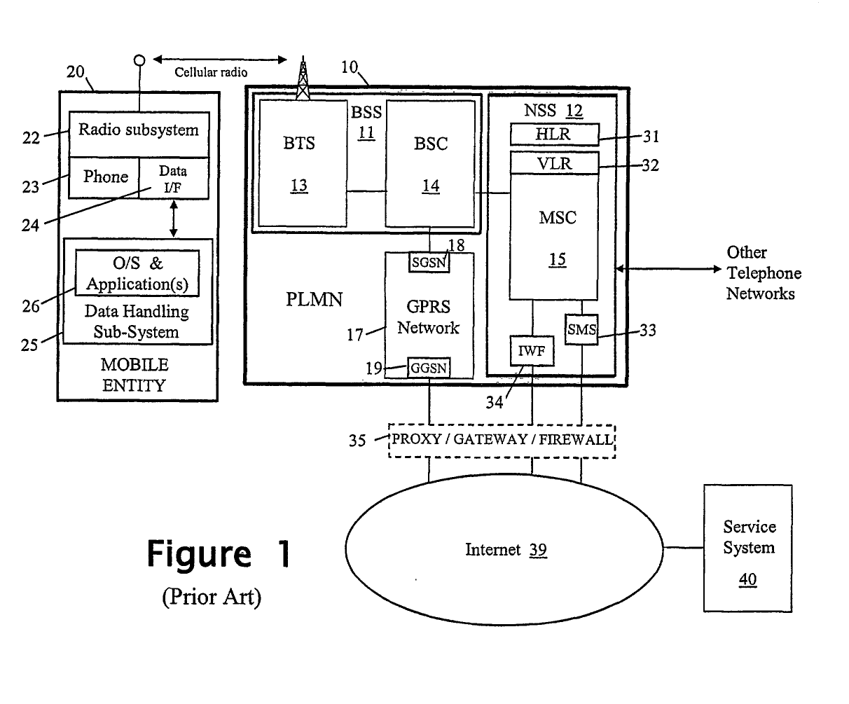

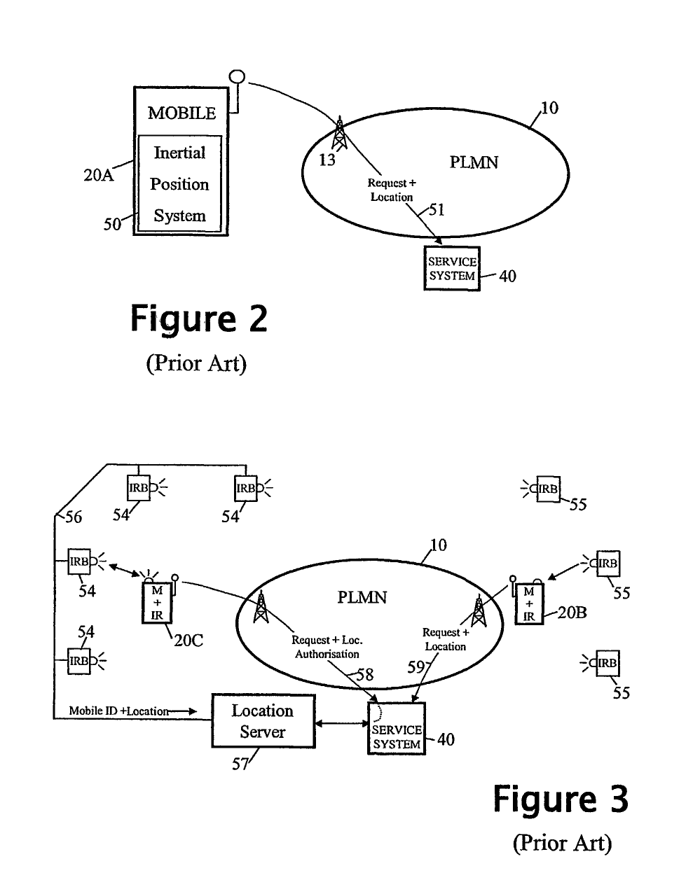

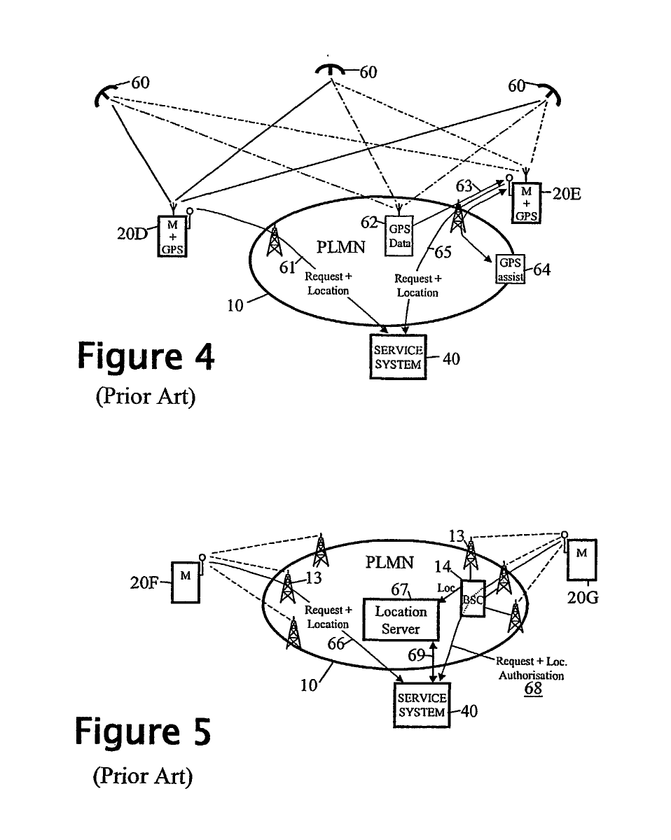

It is to be understood that the present invention is not limited to the specifics of the mobile entity and communication infrastructure and location discovery means shown in FIGS. 6 and 7, and the generalisations discussed above in relation to FIGS. 1 to 5 regarding these elements apply equally to the operational context of the described embodiments of the invention. Furthermore, whilst the service system 40 is shown in FIG. 7 as connected to the public Internet, it could be connected to a GPRS network 17 of PLMN 10 or to another fixed data network interfacing directly or indirectly with the network 17 or network 39.

1. A control method for an item of equipment that is provided with particular functionality for using target data on a removable data carrier or in a received data file, the method involving enabling said particular functionality upon at least a first location condition being satisfied, this condition being tested for by:
(a) obtaining current-location data representing the current location of the equipment;
(b) comparing the current-location data with authorised-location data that is associated with the target data and represents a predetermined authorised location or locality for operation of said particular functionality of the equipment in relation to the associated target data; and
(c) generating a location-match signal upon the comparison step (b) indicating that the equipment is currently located in said authorised location or locality.

2. A method according to claim 1, wherein the authorized-location data is stored on said removable data carrier or in said received data file, the equipment reading said information carrier to obtain said authorized-location data.

3. A method according to claim 2, wherein steps (b) and (c) are carried out at the equipment.

4. A method according to claim 2, wherein the equipment has a communication sub-system enabling it to communicate with a remote service system via a communications infrastructure, steps (b) and (c) being carried out at the remote service system and this system, following the generation of a location-match signal in step (c), passing this signal or one produced after testing any further conditions set to be tested at the remote system, to the equipment via said communications infrastructure.

5. A method according to claim 4, wherein the current location data is obtained by the service system from a location discovery system separate from the equipment.

6. A method according to claim 4, wherein the communications infrastructure is a cellular radio infrastructure and the communication sub-system of the equipment is a cellular radio device, the infrastructure having a location discovery system for determining the location of the cellular radio device and thus of the equipment, and the remote service system obtaining said current-location data from the location discovery system either directly or via the equipment.

7. A method according to claim 1, wherein the equipment has a communication sub-system enabling it to communicate with a remote service system via a communications infrastructure, the remote service system storing authorised-location data against identity information, and the equipment reading said data carrier or file to derive identity information which it passes to the service system where it is used to access the corresponding authorized-location data for use in, step (b).

8. A method according to claim 7, wherein the authorized location data is returned to the equipment and steps (b) and (c) are carried out at the equipment.

9. A method according to claim 7, wherein steps (b) and (c) are carried out at the service system and this system, following the generation of a location-match signal in step (c), passing this signal or one produced after testing any further conditions set to be tested at the service system, to the equipment via said communications infrastructure.

10. A method according to claim 9, wherein the current location data is obtained by the service system from a separate location discovery system separate from the equipment.

11. A method according to claim 9, wherein the communications infrastructure is a cellular radio infrastructure and the communication sub-system of the equipment is a cellular radio device, the infrastructure having a location discovery system for determining the location of the cellular radio device and thus of the equipment, and the remote service system obtaining said current-location data from the location discovery system either directly or via the equipment.

12. A method according to claim 1, wherein items of authorized-location data are stored in the equipment in association with identity data, the equipment reading said data carrier or file to derive identity information which it then correlates with said identity data to determine the authorized-location data item applicable to the data carrier or file, steps (b) and (c) then being carried out at the equipment using this item of authorized-location data.

13. A method according to claim 12, wherein said identity information identifies a classification of the target data.

14. A method according to claim 1, wherein the target data is encrypted and the enabling of said particular functionality involves providing a decryption key to the functionality to enable it to decrypt said target data.

15. Equipment including particular functionality for using target data provided on a removable data carrier or in a received data file, the equipment further including a control sub-system for enabling said particular functionality upon at least a first location condition being satisfied, the control sub-system comprising, for testing this condition:
a location discovery arrangement for obtaining current-location data representing the current location of the equipment;
a read arrangement for reading from the removable data carrier or received data file authorized-location data representing a predetermined authorised location or locality for operation of said particular functionality of the equipment; and
a comparison arrangement for comparing the current-location data with the authorized-location data whereby to generate a location-match signal upon this comparison indicating that the equipment is currently located in said authorised location or locality.

16. Equipment including particular functionality for using target data provided on a removable data carrier or in a received data file, the equipment further including a control sub-system for enabling said particular functionality upon at least a first location condition being satisfied, the control sub-system comprising, for testing this condition:
a location discovery arrangement for obtaining current-location data representing the current location of the equipment;
a store for storing in association with identity data, authorized-location data representing a predetermined authorized location or locality for operation of said particular functionality of the equipment
a read arrangement for reading from the removable data carrier or received data file identity information relating to the target data;
a data retrieval arrangement for using the identity information to access the authorized-location data held in said store in respect of the identity data matching the identity information; and
a comparison arrangement for comparing the current-location data with the accessed authorized-location data whereby to generate a location-match signal upon this comparison indicating that the equipment is currently located in said authorised location or locality.

17. A service system for determining when an item of equipment is located at a location where particular functionality of the equipment is authorised for use in accessing target data provided on a removable data carrier or in a received data file, the service system comprising:
a communications sub-system for communicating with said equipment both to receive therefrom identity information concerning said target data, and to return to the equipment enablement signals for enabling said particular functionality for accessing the target data;
a location discovery arrangement for obtaining current-location data representing the current location of the equipment;
a store for storing in association with identity data, authorized-location data representing a predetermined authorized location or locality for operation of said particular functionality of the equipment;
a data retrieval arrangement for using identity information received from the equipment via the communication sub-system to access the authorized-location data held in said store in respect of identity data matches the identity information; and
a comparison arrangement for comparing the current-location data with the accessed authorized-location data whereby to generate a location-match signal upon this comparison indicating that the equipment is currently located in said authorised location or locality.

18. A service system according to claim 16, wherein the system, following the generation of a location-match signal and successful testing for any further conditions set to be tested at the system, is operative to return to the equipment a decryption key for decrypting said target data.

19. A removable data carrier on which is registered target content data and authorised location data, the latter representing a predetermined authorized location or locality where access to the target data is permitted.
